(19) United States
(12) Patent Application Publication
(10) Pub. No.: US 2023/0281266 A1
(43) Pub. Date: Sep. 7, 2023

(54) CASCADED IMPULSE CONVOLUTION SHAPING METHOD AND APPARATUS FOR NUCLEAR SIGNAL

(71) Applicant: Sichuan X-STAR Technology of M&C Co., Ltd, Chengdu (CN)

(72) Inventors: Jianbin Zhou, Chengdu (CN); Min Wang, Chengdu (CN)

(73) Assignee: Sichuan X-STAR Technology of M&C Co., Ltd, Chengdu (CN)

(21) Appl. No.: 18/087,853

(22) Filed: Dec. 23, 2022

(30) Foreign Application Priority Data
Mar. 2, 2022 (CN) 202210196100.0

(51) Int. Cl. G01T 1/36

(52) U.S. Cl. CPC G01T 1/361

(57) ABSTRACT

A cascaded impulse convolution shaping method for a nuclear signal includes: obtaining a detector signal by using a detector; convolving the detector signal with a Gaussian signal by using a multistage cascaded shaping system; and performing double-exponential impulse shaping, and generating, by using the multistage cascaded shaping system, a Gaussian-shaped impulse signal with a narrow pulse width for analysis. Based on the characteristic that a multistage cascaded convolution of a complex system can exchange a convolution sequence, the detector signal can first pass through a cascaded inverse system to form an impulse signal, and then the impulse signal is convolved with the Gaussian signal to generate a cascaded impulse convolution signal. This method can be extended to a three-exponential or four-exponential signal for Gaussian, trapezoidal, cyclotron up-scattering process (CUSP), cosine-squared distribution, and Cauchy distribution shaping. A cascaded impulse convolution shaping apparatus for a nuclear signal is further provided.

### CROSS REFERENCE TO THE RELATED APPLICATIONS

This application is based upon and claims priority to Chinese Patent Application No. 202210196100.0, filed on Mar. 2, 2022, the entire contents of which are incorporated herein by reference.

### TECHNICAL FIELD

The present disclosure relates to the technical field of processing nuclear signals and specifically to a cascaded impulse convolution shaping method and apparatus for a nuclear signal.

### BACKGROUND

A nuclear signal carries a variety of information, such as energy and type of radiating particle, and the time of occurrence of a radiation event. Nuclear information extracted from the nuclear signal can be used for basic scientific research on a nuclear property, a nuclear structure, nuclear decay, and the like. To obtain accurate nuclear information in nuclear science and technology, it is often necessary to use an electronic method to detect the nuclear signal and extract the nuclear information from the nuclear signal. With the development of high-speed digital processing chips and high-speed analog-to-digital converters (ADCs), digitization and digital processing technologies for nuclear signals are gradually becoming developed.

In the prior art, a digital processing method for the nuclear signal is a complementary method, which focuses on researching digital trapezoidal, cyclotron up-scattering process (CUSP), and Gaussian filters and uses a sawtooth filter to research pulse shape discrimination (PSD) and impulse filter and the like to research a high count rate.

However, the prior art has the following problems:
1. Despite good anti-noise capability, the existing Gaussian filter has a more complex algorithm and consumes more hardware resources, which makes it difficult to construct a real-time digital Gaussian filter.
2. A complex digital algorithm cannot be deployed on a digital chip due to a high technical threshold, a long development cycle, and poor floating-point computing capability. In addition, digital chip resources are limited, and the implementation of the algorithm is severely limited.

### SUMMARY

To resolve the above problems in the prior art, the present disclosure provides a cascaded impulse convolution shaping method and apparatus for a nuclear signal to perform fine double-exponential impulse shaping on the signal and then perform cascaded convolution on the signal and a standard digital Gaussian signal to achieve the Gaussian shaping of the signal, directly convolve the digital Gaussian signal with a double-exponential impulse shaping filter signal to achieve a digital Gaussian shaping filter for the nuclear signal and realize three-exponential or four-exponential Gaussian shaping, cosine-squared shaping, Cauchy distribution shaping, and the like through extension.

To achieve the above objective, the present disclosure adopts the following technical solutions by providing a cascaded impulse convolution shaping method for a nuclear signal, including:
S1: obtaining a detector signal by using a detector;
S2: taking the detector signal as an input signal, enabling the input signal to pass through a multistage cascaded shaping system, convolving the input signal with a target signal by using a cascaded convolution system, performing impulse shaping by using a cascaded inverse system to generate a cascaded impulse convolution signal for analysis, and obtaining a function expression of the cascaded impulse convolution signal;
S3: performing, based on a characteristic that a cascaded convolution of the multistage cascaded shaping system supports the exchange of a convolution sequence, impulse shaping on the input signal by using the cascaded inverse system to form an impulse signal and obtaining a system function expression of impulse shaping of the input signal; and
S4: convolving the impulse signal with the target signal by using the cascaded convolution system to generate a cascaded impulse convolution shaping signal and obtaining a function expression of the multistage cascaded shaping system.

Preferably, in S2 of the present disclosure, the target signal includes a standard Gaussian signal, a cosine-squared signal, a Cauchy distribution signal, and a trapezoidal signal. The impulse signal is convolved with the target signal, and then impulse shaping is performed by using the cascaded inverse system to generate the cascaded impulse convolution signal of the detector signal, where a function expression of the cascaded impulse convolution signal is obtained, as shown in formula (23):

A2[n]=z[n]*g[n]*h[n] (23),

where A2[n] represents the function expression of the cascaded impulse convolution signal, z[n] represents a function expression of the input signal, g[n] represents an expression of the standard Gaussian signal, h[n] represents a system function expression of double-exponential impulse shaping, and n represents a point sequence of the collected input signal.

Preferably, S3 of the present disclosure specifically includes:
S3.1: defining the input signal z[n] as a double-exponential signal, inputting the input signal z[n] into a first-stage INV_RC system to output a single-exponential attenuation signal y[n], where the input signal z[n] is expressed by using formula (1), and the single-exponential attenuation signal y[n] is expressed by using formula (2):

$$z [ n ] = A ( {e}^{- \frac{n}{M}} - {e}^{- \frac{n}{m}} ) , m > M , n \geq 0 \qquad ( 1 )$$

$$y [ n ] = INV\_RC ( z [ n ] , m ) , \qquad ( 2 )$$

where m and M represent system parameters of the double-exponential signal; n represents the point sequence of the collected input signal; and INV_RC represents inverse RC, where INV represents an inverse operation, and RC represents a resistor R and a capacitor C in a circuit, namely impacts from the RC in the circuit are removed through the inverse operation;
S3.2: inputting the single-exponential attenuation signal y[n] into a second-stage INV_RC system to output an impulse response signal p[n], where the impulse response signal p[n] is expressed by using formula (3):

$$p [ n ] = \frac{1}{M} INV\_RC ( y [ n ] , M ) ; \qquad ( 3 )$$

S3.3: obtaining the following formulas (4) and (5) based on digital solution comprehensions of formulas (2) and (3) of an INV_RC operator:

$$\sum y [ n ] = \sum z [ n ] + mz [ n ] \qquad ( 4 )$$

$$\sum p [ n ] = ( \frac{1}{M} ) ( \sum y [ n ] + My [ n ] ) , \qquad ( 5 )$$

where INV_RC represents the inverse RC, where INV represents the inverse operation, and RC represents the resistor R and the capacitor C in the circuit, namely the impacts from the RC in the circuit are removed through the inverse operation;

substituting formula (4) into formula (5) to obtain a digital conversion expression of formula (6) for converting the input signal z[n] into the impulse response signal p[n] by using the cascaded inverse system, as shown below:

$$\sum p [ n ] = ( \frac{1}{M} ) ( \sum z [ n ] + mz [ n ] + {M ( \sum z [ n ] + mz [ n ] )}^{′} ) ; \qquad ( 6 )$$

and performing a differential calculation on two sides of the formula (6) to obtain formulas (7), (8), and (9), as shown below:

$$p [ n ] = ( \frac{1}{M} ) ( z [ n ] + {m ( z [ n ] )}^{′} + {M ( \sum z [ n ] + mz [ n ] )}^{″} ) \qquad ( 7 )$$

$$p [ n ] = ( \frac{1}{M} ) ( z [ n ] + {m ( z [ n ] )}^{′} + M ( {z [ n ]}^{′} + {mz [ n ]}^{″} ) ) \qquad ( 8 )$$

$$p [ n ] = \frac{\begin{matrix}( 1 + m + M + m \cdot M ) \cdot z [ n ] - ( m + M + 2 \cdot M \cdot m ) \cdot \\ z [ n - 1 ] + M \cdot m \cdot z [ n - 2 ]\end{matrix}}{M} ; and \qquad ( 9 )$$

S3.4: sorting out the formula (8) to obtain a formula (10), as shown below:

$$p [ n ] = ( \frac{1}{M} ) ( z [ n ] + ( m + M ) {( z [ n ] )}^{′} + {Mmz [ n ]}^{″} ) = ( \frac{1}{M} ) ( δ [ n ] + ( m + M ) {( δ [ n ] )}^{′} + Mm {δ [ n ]}^{″} ) * z [ n ] ; \qquad ( 10 )$$

and obtaining a system function expression of impulse shaping of the double-exponential signal according to the formula (10), as shown in formula (11):

$$h 1 [ n ] = ( \frac{1}{M} ) ( δ [ n ] + ( m + M ) {( δ [ n ] )}^{′} + Mm {δ [ n ]}^{″} ) . \qquad ( 11 )$$

Preferably, in the present disclosure, when the input signal z[n] is defined as a single-exponential signal, m=0, and a system function expression of impulse shaping of the single-exponential signal is obtained according to formula (11), as shown in formula (12):

$$h 2 [ n ] = ( \frac{1}{M} ) ( δ [ n ] + M \cdot {( δ [ n ] )}^{′} ) . \qquad ( 12 )$$

Preferably, S3 of the present disclosure specifically includes:
S3.1: when the input signal z[n] is defined as a double-exponential signal with recoiling, inputting the input signal z[n] into the first-stage INV_RC system, where an output signal of the first-stage INV_RC system is y[n], the input signal z[n] is expressed by using formula (13), and the output signal y[n] is expressed by using formula (14):

$$z [ n ] = A ( \frac{m}{m - M} {e}^{- \frac{n}{M}} - \frac{M}{m - M} {e}^{- \frac{n}{m}} ) , m > M , n \geq 0 \qquad ( 13 )$$

$$y [ n ] = \sum z [ n ] + m . z [ n ] = z [ n ] * ε [ n ] * ( {m ( δ [ n ] )}^{′} + δ [ n ] ) ; \qquad ( 14 )$$

and
S3.2: deducing a system function expression of impulse shaping of the double-exponential signal with recoiling based on a procedure obtained according to the formula (11), as shown in formula (15), where it is known that the formula (14) is a function expression of the first-stage INV_RC system:

$$h 3 [ n ] = \frac{1}{M} ( δ [ n ] + M . {( δ [ n ] )}^{′} ) * ε [ n ] * ( {m ( δ [ n ] )}^{′} + δ [ n ] ) = \frac{1}{M} ( δ [ n ] + ( m + M ) {( δ [ n ] )}^{′} + {Mm ( δ [ n ] )}^{″} ) * ε [ n ] \qquad ( 15 )$$

Preferably, in S4 of the present disclosure, the target signal includes a standard Gaussian signal, a cosine-squared signal, a Cauchy distribution signal, and a trapezoidal signal; the impulse signal is convolved with the target signal by using the cascaded convolution system to generate the cascaded impulse convolution shaping signal, where a function expression of the cascaded impulse convolution shaping signal is as shown in formula (16):

A1[n]=z[n]*h[n]*g[n] (16),

where A1[n] represents the function expression of the cascaded impulse convolution shaping signal, h[n] represents a system function expression of double-exponential impulse shaping, and g[n] represents the standard Gaussian signal.

Preferably, in the present disclosure, when the target signal is the standard Gaussian signal, the impulse signal is convolved with the standard Gaussian signal to generate the cascaded impulse convolution shaping signal of the input signal, and the formulas (11), (12), and (15) are substituted into the formula (16) separately. Based on the characteristic that the cascaded convolution of the multistage cascaded shaping system supports the exchange of the convolution sequence, function expressions of the multistage cascaded shaping system are obtained, as shown in formulas (17), (18), and (19):

$$G 1 [ n ] = g [ n ] * h 1 [ n ] = \frac{1}{M} {Be}^{- \frac{{( n - b )}^{2}}{2 {c}^{2}}} * ( δ [ n ] + ( m + M ) {( δ [ n ] )}^{′} + M \cdot {( δ [ n ] )}^{″} ) \qquad ( 17 )$$

$$G 2 [ n ] = g [ n ] * h 2 [ n ] = \frac{1}{M} {Be}^{- \frac{{( n - b )}^{2}}{2 {c}^{2}}} * ( δ [ n ] + M \cdot {( δ [ n ] )}^{′} ) \qquad ( 18 )$$

$$G 3 [ n ] = g [ n ] * h 3 [ n ] = \frac{1}{M} {Be}^{- \frac{{( n - b )}^{2}}{2 {c}^{2}}} * ( δ [ n ] + ( m + M ) {( δ [ n ] )}^{′} + M \cdot {m ( δ [ n ] )}^{″} ) * ε [ n ] , \qquad ( 19 )$$

where g[n] represents the function expression of the target signal, and the target signal herein is the standard Gaussian signal.

Preferably, the present disclosure replaces the standard Gaussian signal with the cosine-squared signal or the Cauchy distribution signal and convolves the cosine-squared signal or the Cauchy distribution signal with the impulse signal to generate an impulse cosine-squared shaping signal of the detector signal or an impulse Cauchy distribution shaping signal of the detector signal, where a coefficient of digital Gaussian convolution is determined by the formula (20), a coefficient of cosine-squared convolution is determined by the formula (21), and a coefficient of digital Cauchy convolution is determined by the formula (22):

$$C 1 [ n ] = exp ( - ln ( 2 ) * {( \frac{n}{H} )}^{2} ) \qquad ( 20 )$$

$$C 2 [ n ] = {COS}^{2} ( π n / 2 H ) \qquad ( 21 )$$

$$C 3 [ n ] = {H}^{2} / ( {H}^{2} + 4 {n}^{2} ) , \qquad ( 22 )$$

where n represents the point sequence of the collected input signal, and H represents a half-width of the corresponding signal of each of the formulas. Herein, C1 [n], C2 [n], and C3 [n] are equivalent to our commonly used f(x) that represents a function expression, where n is a variable.

The present disclosure further provides a cascaded impulse convolution shaping apparatus for a nuclear signal, including:
a data collection unit configured to collect a detector signal in real-time and transmit the detector signal to an Advanced RISC Machines (ARM) processor by using a chip;
an impulse shaping unit configured to perform impulse shaping on the detector signal by using a cascaded inverse system to form an impulse signal;
a convolution shaping unit configured to convolve a target signal with the impulse signal formed by the impulse shaping unit to generate a cascaded impulse convolution shaping signal; and a Transmission Control Protocol (TCP)/Internet Protocol (IP) network configured to perform the setting of parameters based on different detectors and signal adjustment circuits.

Preferably, the target signal in the present disclosure includes a standard Gaussian signal, a cosine-squared signal, a Cauchy distribution signal, and a trapezoidal signal.

Compared with the prior art, the technical solutions of the present disclosure have the following advantages/beneficial effects:
1. The present disclosure is based on a digital Gaussian filtering method in which Gaussian convolution is performed on a detector signal after impulse shaping or a digital Gaussian filtering method in which impulse shaping is performed after Gaussian convolution to easily adjust the parameters of Gaussian shaping for different detector signals.
2. The present disclosure removes a tail of a pulse after shaping, such that the pulse is more symmetrical and the width of the pulse is narrowed, which is more suitable for energy spectrum measurement at a high count rate.
3. The present disclosure reduces a scale of a multiplier and is generalized to the Gaussian shaping of double-exponential and more complex signals.
4. The real-time digital Gaussian shaping method designed in the present disclosure is relatively simple and can operate with an analog-to-digital (AD) sampling system in parallel at a high speed. A scintillation detector can be deployed on a medium-end field programmable gate array (FPGA) device with more than dozens of multipliers. A semiconductor detector with higher resolution needs to be deployed on a medium or high-end FPGA device with more than hundreds of multipliers or digital signal processors (DSPs).
5. The present disclosure realizes a digital cascaded impulse convolution shaping filter for a nuclear signal and can be generalized to a three-exponential or four-exponential signal for Gaussian, trapezoidal, cyclotron up-scattering process (CUSP), cosine-squared distribution, and Cauchy distribution shaping.

### BRIEF DESCRIPTION OF THE DRAWINGS

To describe the technical solutions in the implementations of the present disclosure more clearly, the following briefly describes the accompanying drawings required for describing the implementations. It should be understood that the following accompanying drawings show merely some embodiments of the present disclosure and therefore should not be regarded as a limitation on the scope. A person of ordinary skill in the art may still derive other related drawings from these accompanying drawings without creative efforts.

FIG. 1 is a schematic diagram of a simulation of a continuous step signal and the first derivative of a Gaussian signal (c=60/√2) (input signal) according to the present disclosure;

FIG. 2 is a schematic diagram of a convolution simulation of a continuous step signal and the first derivative of a Gaussian signal (output signal) according to the present disclosure;

FIG. 3 is a schematic diagram of digital impulse shaping based on a cascaded inverse system according to the present disclosure;

FIG. 4 is a schematic diagram of a simulated double-exponential impulse shaping of a detector signal according to the present disclosure;

FIG. 5 is a schematic diagram of a simulated Gaussian shaping of a detector impulse signal according to the present disclosure;

FIG. 6 is a schematic diagram of a simulated Gaussian signal with a short rising edge time according to the present disclosure;

FIG. 7 is a schematic diagram of a simulated Gaussian signal with a long rising edge time according to the present disclosure;

FIG. 8 is a schematic diagram of a simulated short cosine-squared rising edge according to the present disclosure;

FIG. 9 is a schematic diagram of a simulated long cosine-squared rising edge according to the present disclosure;

FIG. 10 is a schematic diagram of a simulated impulse signal and Gaussian shaping signal convolution of a detector according to the present disclosure;

FIG. 11 is a schematic diagram of a convolution simulation of a step signal and the first derivative of a cosine-squared distribution signal (H (full width at half maximum)=128 sampling points) according to the present disclosure;

FIG. 12 is a schematic diagram of a convolution simulation of a continuous step signal and the first derivative of a Cauchy distribution signal according to the present disclosure;

FIG. 13 is a schematic diagram of a simulated digital trapezoidal-shaped convolution signal of a single-exponential signal according to the present disclosure;

FIG. 14 is a schematic diagram of a simulated digital trapezoidal-shaped convolution signal of a single-exponential signal according to the present disclosure;

FIG. 15 is a schematic diagram of a simulated digital trapezoidal-shaped convolution signal of a double-exponential signal according to the present disclosure;

FIG. 16 is a schematic diagram of a test performed on a Gaussian-shaped detector signal (NaI detector, 1.65μ S digital pulse width H=16, 65-point Gauss) according to the present disclosure;

FIG. 17 is a schematic diagram of a test performed on a Gaussian-shaped energy spectrum (NaI detector, Cs-137 FWHM: 6.81%, 1.65 p S digital pulse width) according to the present disclosure;

FIG. 18 is a schematic diagram of a test performed on a Gaussian-shaped energy spectrum (Cs-137+K−40+Th-232) according to the present disclosure; and

FIG. 19 is a schematic diagram of convolution impulse shaping based on a cascaded inverse system according to Embodiment 1 of the present disclosure.

### DETAILED DESCRIPTION OF THE EMBODIMENTS

To make the objectives, technical solutions, and advantages of the present disclosure clear, the technical solutions in the implementations of the present disclosure will be clearly and completely described below. It will become obvious that the described implementations are some, rather than all of the implementations of the present disclosure. Based on the implementations of the present disclosure, all other implementations obtained by a person of ordinary skill in the art without creative efforts shall fall within the protection scope of the present disclosure. Therefore, the following detailed description of the implementations of the present disclosure is not intended to limit the protection scope of the present disclosure but merely represents the selected implementations of the present disclosure.

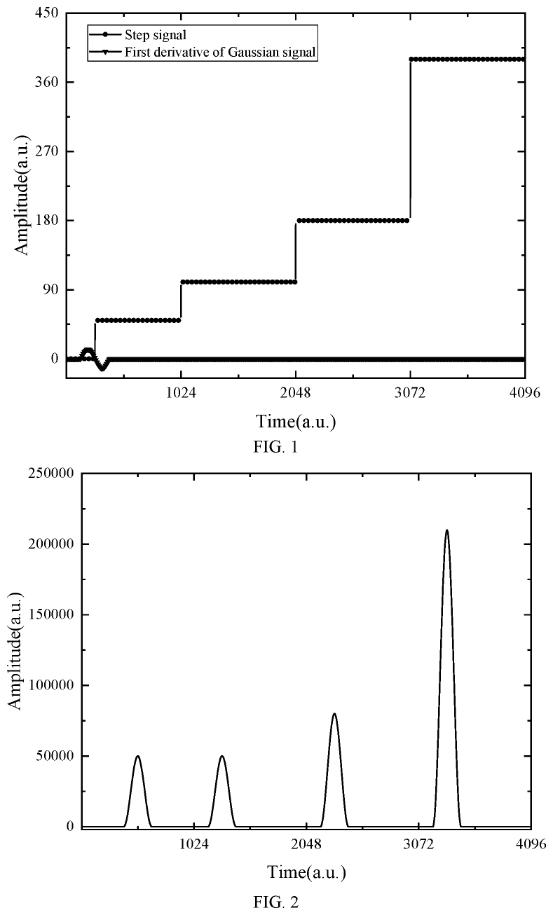

If a Gaussian signal is directly convolved with a detector signal, a tail of a processed signal is very long. FIG. 1 shows a convolution simulation of a first derivative of the Gaussian signal and a step signal, and FIG. 2 is a simulation result. It can be seen that an input signal may be converted into a continuous step signal for processing.

### Embodiment 1

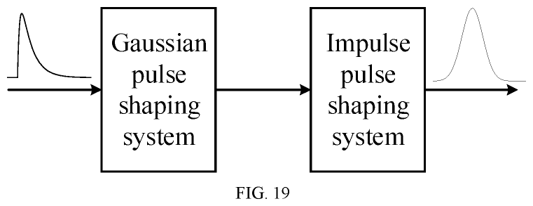

As shown in FIG. 19, the present disclosure provides a cascaded impulse convolution shaping method for a nuclear signal, including the following steps.
S1: A detector signal is obtained by using a detector.
S2: As shown in FIG. 19, the detector signal is taken as an input signal, the input signal is enabled to pass through a multistage cascaded shaping system, and the input signal is convolved with a target signal by using a cascaded convolution system. Impulse shaping is performed by using a cascaded inverse system to generate a cascaded impulse convolution signal for analysis, and a function expression of the cascaded impulse convolution signal is obtained.

The target signal includes a standard Gaussian signal, a cosine-squared signal, a Cauchy distribution signal, and a trapezoidal signal. The impulse signal is convolved with the target signal, and impulse shaping is performed by using the cascaded inverse system to generate the cascaded impulse convolution signal of the detector signal, where a function expression of the cascaded impulse convolution signal is obtained, as shown in formula (23):

A2[n]=z[n]*g[n]*h[n] (23),

where A2[n] represents the function expression of the cascaded impulse convolution signal, z[n] represents a function expression of the input signal, g[n] represents an expression of the standard Gaussian signal, h[n] represents a system function expression of double-exponential impulse shaping, and n represents a point sequence of the collected input signal.

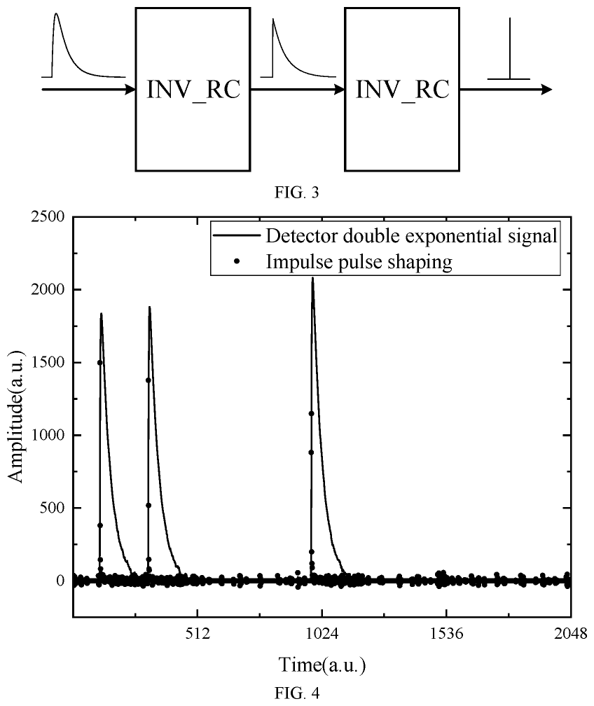

As shown in FIG. 1 and FIG. 2, a Gaussian signal is convolved with a continuous step signal to generate a Gaussian-shaped pulse signal with a very narrow pulse width for easy analysis. Since a differential of the continuous step signal is an impulse signal, the detector signal is first converted into an impulse signal. FIG. 3 shows the cascaded inverse system in the present disclosure. The present disclosure converts a double-exponential signal into an impulse signal by using the cascaded inverse system.
S3: Impulse shaping is performed on the input signal by using the cascaded inverse system based on a characteristic that a cascaded convolution of the multistage cascaded shaping system supports the exchange of a convolution sequence to form the impulse signal. A system function expression of impulse shaping of the input signal is obtained, where S3 in the present disclosure specifically includes the following steps:
S3.1: The input signal z[n] is defined as the double-exponential signal. The input signal is input into a first-stage INV_RC system to output a single-exponential attenuation signal y[n], where the input signal z[n] is expressed by using formula (1), and the single-exponential attenuation signal y[n] is expressed by using formula (2):

$$z [ n ] = A ( {e}^{- \frac{n}{M}} - {e}^{- \frac{n}{m}} ) , m > M , n \geq 0 \qquad ( 1 )$$

$$y [ n ] = INV\_RC ( z [ n ] , m ) , \qquad ( 2 )$$

where m and M represent system parameters of the double-exponential signal; n represents a point sequence of the collected input signal; and
INV_RC represents inverse RC, where INV represents an inverse operation, and RC represents a resistor R and a capacitor C in a circuit, namely impacts from the RC in the circuit are removed through the inverse operation.
S3.2: The single-exponential attenuation signal y[n] is input into a second-stage INV_RC system to output an impulse response signal p[n], where the impulse response signal p[n] is expressed by using formula (3):

$$p [ n ] = \frac{1}{M} INV\_RC ( y [ n ] , M ) \qquad ( 3 )$$

S3.3: The following formulas (4) and (5) are obtained based on digital solution comprehensions of formulas (2) and (3) of an INV_RC operator:

$$\sum y [ n ] = \sum z [ n ] + mz [ n ] \qquad ( 4 )$$

$$\sum p [ n ] = ( \frac{1}{M} ) ( \sum y [ n ] + My [ n ] ) . \qquad ( 5 )$$

Formula (4) is substituted into formula (5) to obtain a digital conversion expression of formula (6) for converting the input signal z[n] into the impulse response signal p[n] by using the cascaded inverse system, as shown below:

$$\sum p [ n ] = ( \frac{1}{M} ) ( \sum z [ n ] + mz [ n ] + {M ( \sum z [ n ] + mz [ n ] )}^{′} ) . \qquad ( 6 )$$

In the present disclosure, after the single-exponential attenuation signal is obtained, an amplitude is reduced to 1/M of the original amplitude. After a single-exponential signal becomes the impulse signal after passing through the second-stage INV_RC system, an amplitude is increased to M times the original amplitude. In this case, the amplitude must be reduced to 1/M of the original amplitude.

A differential calculation is performed on two sides of the formula (6) to obtain formulas (7), (8), and (9), as shown below:

$$p [ n ] = ( \frac{1}{M} ) ( z [ n ] + {m ( z [ n ] )}^{′} + {M ( \sum z [ n ] + mz [ n ] )}^{″} ) \qquad ( 7 )$$

$$p [ n ] = ( \frac{1}{M} ) ( z [ n ] + {m ( z [ n ] )}^{′} + M ( {z [ n ]}^{′} + {mz [ n ]}^{″} ) ) \qquad ( 8 )$$

$$p [ n ] = \frac{\begin{matrix}( 1 + m + M + m \cdot M ) \cdot z [ n ] - \\ ( m + M + 2 \cdot M \cdot m ) \cdot z [ n - 1 ] + M \cdot m \cdot z [ n - 2 ]\end{matrix}}{M} . \qquad ( 9 )$$

S3.4: The formula (8) is sorted out to obtain a formula (10), as shown below:

$$h 1 [ n ] = ( \frac{1}{M} ) ( δ [ n ] + ( m + M ) {( δ [ n ] )}^{′} + Mm {δ [ n ]}^{″} ) . \qquad ( 11 )$$

A system function expression of impulse shaping of the double-exponential signal is obtained according to formula (10), as shown in formula (11):

$$p [ n ] = ( \frac{1}{M} ) ( z [ n ] + ( m + M ) {( z [ n ] )}^{′} + {Mmz [ n ]}^{″} ) = ( \frac{1}{M} ) ( δ [ n ] + ( m + M ) {( δ [ n ] )}^{′} + Mm {δ [ n ]}^{″} ) * z [ n ] . \qquad ( 10 )$$

When the input signal z[n] is defined as the single-exponential signal, m=0, and a system function expression of impulse shaping of the single-exponential signal is obtained according to formula (11), as shown in formula (12):

$$h 2 [ n ] = ( \frac{1}{M} ) ( δ [ n ] + M \cdot {( δ [ n ] )}^{′} ) . \qquad ( 12 )$$

When the input signal is defined as a double-exponential signal with recoiling, the input signal z[n] is input into the first-stage INV_RC system, where an output signal of the first-stage INV_RC system is y[n], the input signal z[n] is expressed by using formula (13), and the output signal y[n] is expressed by using formula (14).

$$z [ n ] = A ( \frac{m}{m - M} {e}^{- \frac{n}{M}} - \frac{M}{m - M} {e}^{- \frac{n}{m}} ) , m > M , n \geq 0 \qquad ( 13 )$$

$$y [ n ] = \sum z [ n ] + m . z [ n ] = z [ n ] * ε [ n ] * ( {m ( δ [ n ] )}^{′} + δ [ n ] ) . \qquad ( 14 )$$

A system function expression of impulse shaping of the double-exponential signal with recoiling is deduced based on a procedure obtained according to formula (11), as shown in formula (15), where it is known that formula (14) is a function expression of the first-stage INV_RC system:

$$h 3 [ n ] = \frac{1}{M} ( δ [ n ] + M . {( δ [ n ] )}^{′} ) * ε [ n ] * ( {m ( δ [ n ] )}^{′} + δ [ n ] ) = \frac{1}{M} ( δ [ n ] + ( m + M ) {( δ [ n ] )}^{′} + {Mm ( δ [ n ] )}^{″} ) * ε [ n ] . \qquad ( 15 )$$

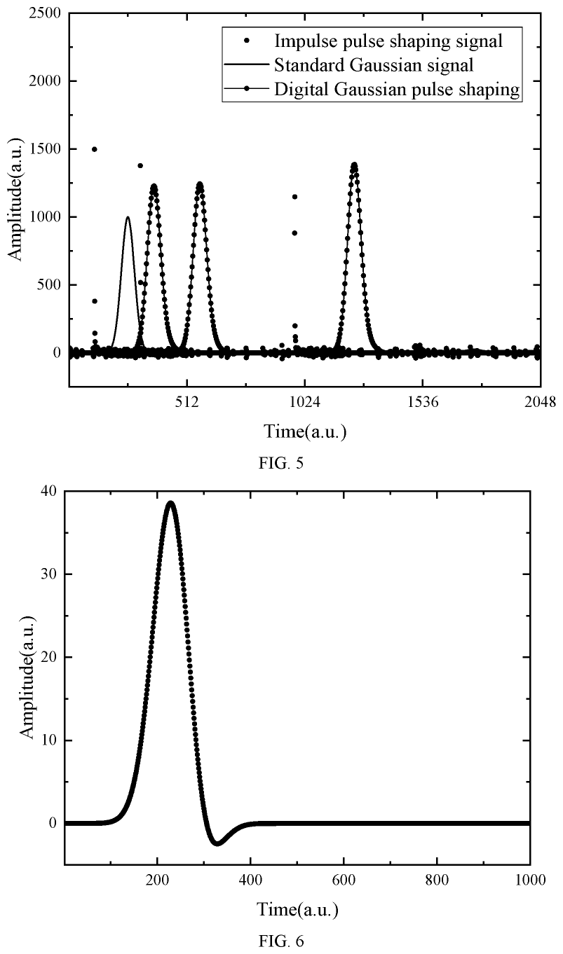

S4: The impulse signal is convolved with the target signal by using the cascaded convolution system to generate a cascaded impulse convolution shaping signal, and a function expression of the multistage cascaded shaping system is obtained. FIG. 4 shows an effect of a double-exponential impulse shaping signal of the detector signal. FIG. 5 is a diagram of the simulated convolution shaping of impulse shaping data in FIG. 4 and the Gaussian signal.
In S4 of the present disclosure, the target signal includes the standard Gaussian signal, the cosine-squared signal, the Cauchy distribution signal, and the trapezoidal signal. The impulse signal is convolved with the target signal by using the cascaded convolution system to generate the cascaded impulse convolution shaping signal, where a function expression of the cascaded impulse convolution shaping signal is as shown in formula (16):

A1[n]=z[n]*h[n]*g[n] (16),

where A1[n] represents the function expression of the cascaded impulse convolution shaping signal, h[n] represents the system function expression of double-exponential impulse shaping, and g[n] represents the standard Gaussian signal.

When the target signal is the standard Gaussian signal, the impulse signal is convolved with the standard Gaussian signal to generate the cascaded impulse convolution shaping signal of the input signal, and formulas (11), (12), and (15) are substituted into the formula (16) separately. Based on the characteristic that the cascaded convolution of the multistage cascaded shaping system supports the exchange of the convolution sequence, function expressions of the multistage cascaded shaping system are obtained, as shown in formulas (17), (18), and (19):

$$G 1 [ n ] = g [ n ] * h 1 [ n ] = \frac{1}{M} {Be}^{- \frac{{( n - b )}^{2}}{2 {c}^{2}}} * ( δ [ n ] + ( m + M ) {( δ [ n ] )}^{′} + M \cdot {m ( δ [ n ] )}^{″} ) \qquad ( 17 )$$

$$G 2 [ n ] = g [ n ] * h 2 [ n ] = \frac{1}{M} {Be}^{- \frac{{( n - b )}^{2}}{2 {c}^{2}}} * ( δ [ n ] + M \cdot {( δ [ n ] )}^{′} ) \qquad ( 18 )$$

$$G 3 [ n ] = g [ n ] * h 3 [ n ] = \frac{1}{M} {Be}^{- \frac{{( n - b )}^{2}}{2 {c}^{2}}} * ( δ [ n ] + ( m + M ) {( δ [ n ] )}^{′} + M \cdot {m ( δ [ n ] )}^{″} ) * ε [ n ] , \qquad ( 19 )$$

where g[n] represents a function expression of the target signal, and the target signal herein is the standard Gaussian signal.

Preferably, the present disclosure replaces the standard Gaussian signal with the cosine-squared signal or the Cauchy distribution signal and convolves the cosine-squared signal or the Cauchy distribution signal with the impulse signal to generate an impulse cosine-squared shaping signal of the detector signal or an impulse Cauchy distribution shaping signal of the detector signal, where a coefficient of digital Gaussian convolution is determined by formula (20), a coefficient of cosine-squared convolution is determined by formula (21), and a coefficient of digital Cauchy convolution is determined by formula (22):

$$C 1 [ n ] = exp ( - ln ( 2 ) * {( \frac{n}{H} )}^{2} ) \qquad ( 20 )$$

$$C 2 [ n ] = {COS}^{2} ( π n / 2 H ) \qquad ( 21 )$$

$$C 3 [ n ] = {H}^{2} / ( {H}^{2} + 4 {n}^{2} ) , \qquad ( 22 )$$

where H represents a half-width of the corresponding signal of each of the formulas.

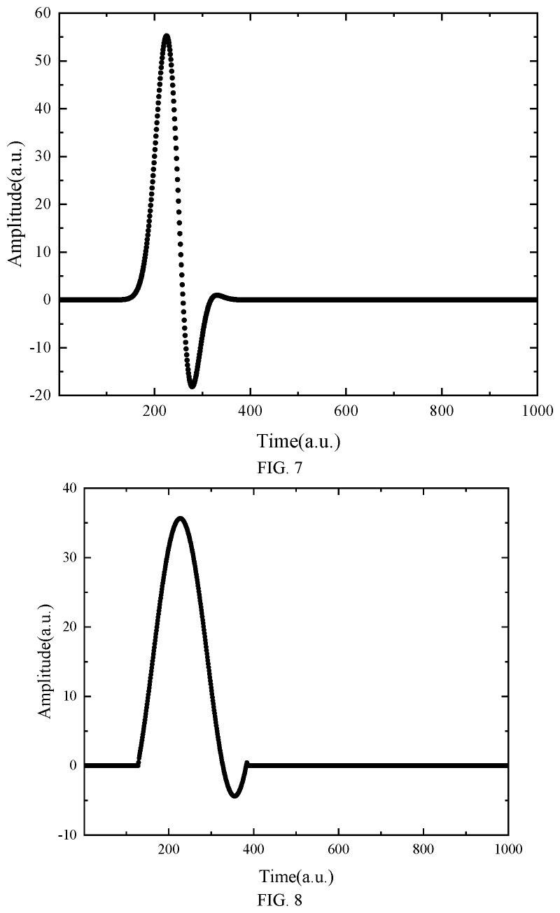

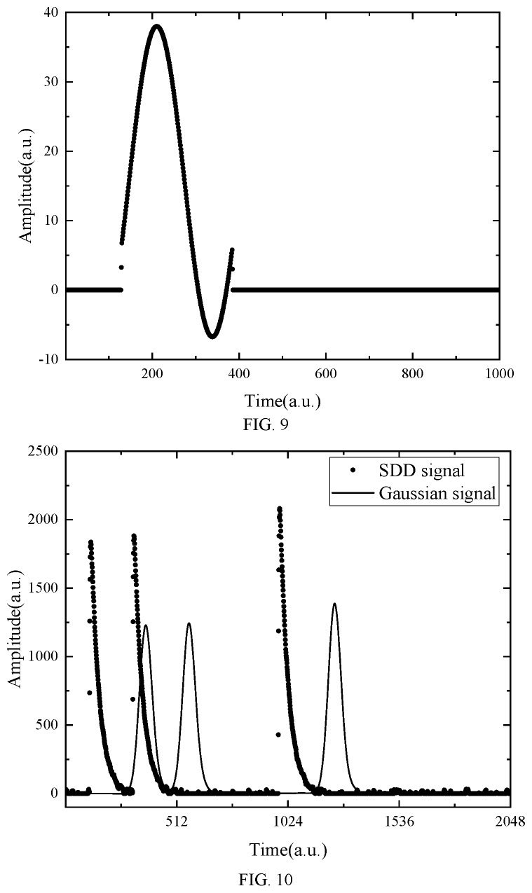

FIG. 6 and FIG. 7 show Gaussian convolution shaping signals of double-exponential signals with different rising times that are obtained through convolution according to the formula (23). FIG. 8 and FIG. 9 show cosine-squared distribution shaped signals of double-exponential signals with different rising times that are generated through convolution according to formula (23). FIG. 10 shows a simulated impulse Gaussian convolution shaping signal of the double-exponential signal.

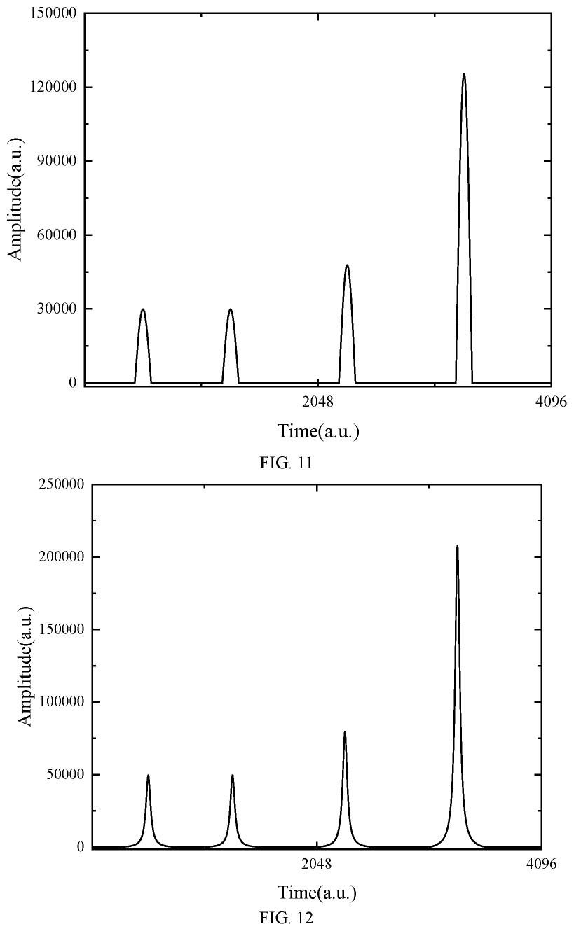

FIG. 11 shows a convolution simulation of a step signal and a first derivative of the cosine-squared distribution signal (H (full width at half maximum)=128 sampling points).

FIG. 12 shows a convolution simulation of the continuous step signal and a first derivative of the Cauchy distribution signal.

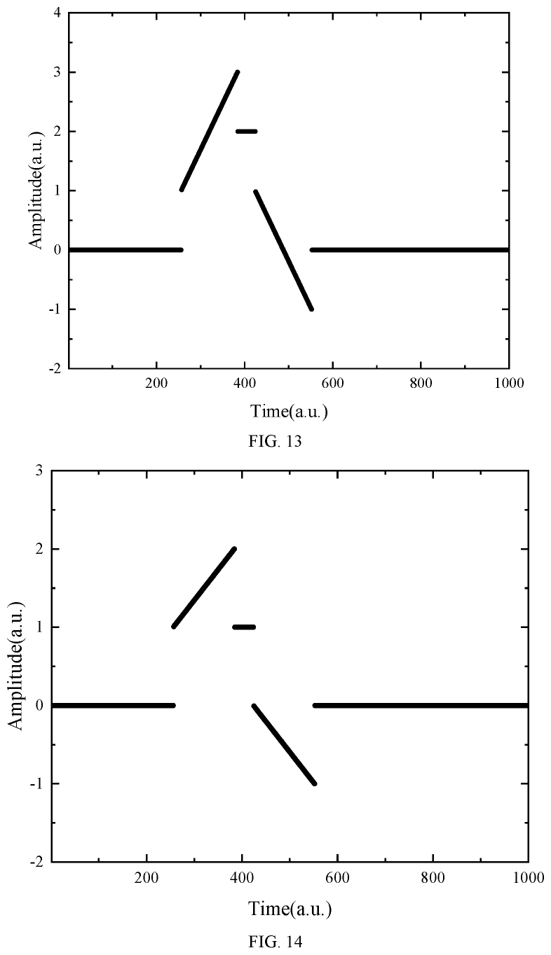

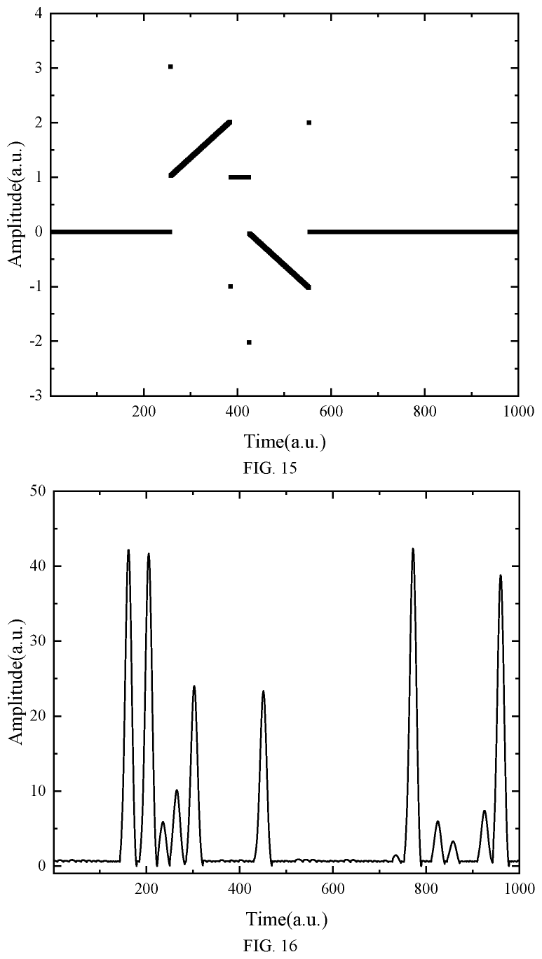

According to the same principle, the present disclosure convolves the trapezoidal signal with a single-exponential impulse system signal to form a digital trapezoidal-shaped convolution signal of the single exponential signal. FIG. 14 simulates an effect when a time constant of the input signal is equal to a number of points on a trapezoidal rising edge. FIG. 13 shows the result of converting the single-exponential signal into the impulse convolution signal and convolving the impulse convolution signal with the trapezoidal signal. Even if the single-exponential signal is used as the convolution signal, normal trapezoidal shaping of the single-exponential signal can also be achieved. According to the same principle, the trapezoidal signal is convolved with a double-exponential impulse system signal to form a digital trapezoidal-shaped convolution signal of the double-exponential signal, as shown in FIG. 15.

The present disclosure further provides a cascaded impulse convolution shaping apparatus for a nuclear signal, including:
a data collection unit configured to collect a detector signal in real-time and transmit the detector signal to an ARM processor by using a chip;
an impulse shaping unit configured to perform impulse shaping on the detector signal by using a cascaded inverse system to form an impulse signal;
a convolution shaping unit configured to convolve a target signal with the impulse signal formed by the impulse shaping unit to generate a cascaded impulse convolution shaping signal, where the target signal includes a standard Gaussian signal, a cosine-squared signal, a Cauchy distribution signal, and a trapezoidal signal; and
a TCP/IP network is configured to perform the setting of parameters based on different detectors and signal adjustment circuits.

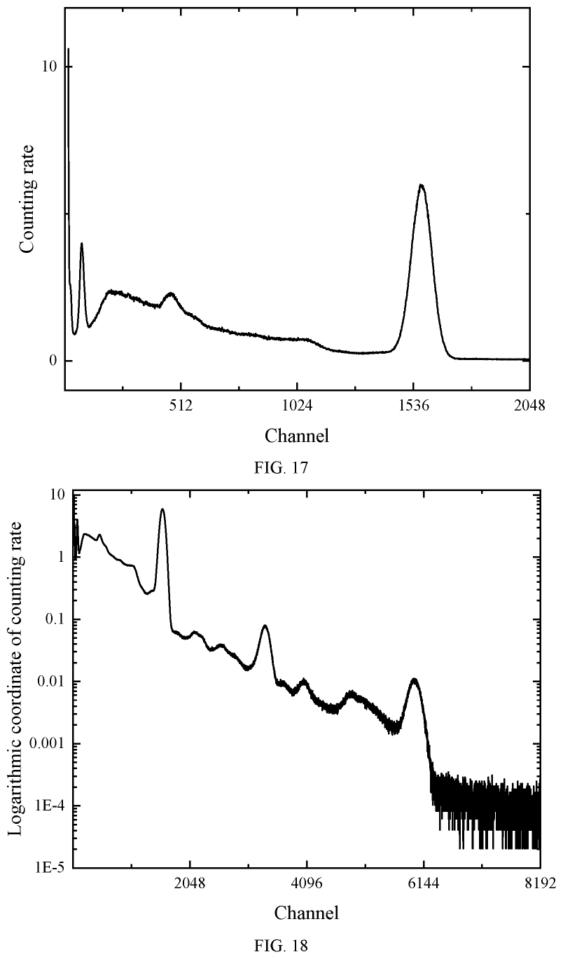

A constructed cascaded impulse convolution digital filter for a nuclear signal (namely, the cascaded impulse convolution shaping apparatus for a nuclear signal) is tested. FIG. 16 shows digital Gaussian shaping of a 65-point NaI detector signal with a half-width of 16 (1.65 us) of a Gaussian signal. It can be seen from FIG. 16 that the signal is symmetrical, closely approximates the Gaussian signal, and has small noise. FIG. 17 shows a Cs-137 energy spectrum obtained after a signal from a Cs-137 source is acquired and subject to Gaussian shaping (Φ75×100 NaI detector, 1.65μ S digital pulse width). FWHM is equal to 6.81%. In addition, half of a peak appears in a low-energy part in FIG. 17 (which is previously removed as noise and cannot be seen, indicating that the method has a strong capability of distinguishing a signal from noise.) Resolution can be improved by about 0.1 to 0.2. FIG. 18 shows a test on a Cs-137+K−40+Th-232 energy spectrum. The energy spectrum is of good linearity.

The above described are merely preferred implementations of the present disclosure. It should be pointed out that the preferred implementations should not be construed as a limitation to the present disclosure, and the protection scope of the present disclosure should be subject to the claims of the present disclosure. Those of ordinary skill in the art may make several improvements and modifications without departing from the spirit and scope of the present disclosure, but the improvements and modifications should fall within the protection scope of the present disclosure.

What is claimed is:

1. A cascaded impulse convolution shaping method for a nuclear signal, comprising:
S1: obtaining a detector signal by using a detector;
S2: taking the detector signal as an input signal, enabling the input signal to pass through a multistage cascaded shaping system, convolving the input signal with a target signal by using a cascaded convolution system, then performing impulse shaping by using a cascaded inverse system to generate a cascaded impulse convolution signal for analysis, and obtaining a function expression of the cascaded impulse convolution signal;
S3: performing, based on a characteristic that a cascaded convolution of the multistage cascaded shaping system supports an exchange of a convolution sequence, impulse shaping on the input signal by using the cascaded inverse system to form an impulse signal, and obtaining a system function expression of the impulse shaping of the input signal, wherein
S3 specifically comprises:
S3.1: when the input signal z[n] is a double-exponential signal, inputting the input signal z[n] into a first-stage INV_RC system to output a single-exponential attenuation signal y[n], wherein the input signal z[n] is expressed by using a formula (1), and the single-exponential attenuation signal y[n] is expressed by using a formula (2):
$$z [ n ] = A ( {e}^{- \frac{n}{M}} - {e}^{- \frac{n}{m}} ) , m > M , n \geq 0 \qquad ( 1 )$$
$$y [ n ] = INV\_RC ( z [ n ] , m ) , \qquad ( 2 )$$
wherein m and M represent system parameters of the double-exponential signal; n represents a point sequence of the collected input signal; and INV_RC represents inverse RC, wherein INV represents an inverse operation, RC represents a resistor R and a capacitor C in a circuit, namely impacts from the RC in the circuit are removed through the inverse operation;
S3.2: inputting the single-exponential attenuation signal y[n] into a second-stage INV_RC system to output an impulse response signal p[n], wherein the impulse response signal p[n] is expressed by using a formula (3):
$$p [ n ] = \frac{1}{M} INV\_RC ( y [ n ] , M ) \qquad ( 3 )$$
S3.3: obtaining formulas (4) and (5) based on digital solution comprehensions of formulas (2) and (3) of an INV_RC operator:
$$\sum y [ n ] = \sum z [ n ] + mz [ n ] \qquad ( 4 )$$
$$\sum p [ n ] = ( \frac{1}{M} ) ( \sum y [ n ] + My [ n ] ) ; \qquad ( 5 )$$
substituting the formula (4) into the formula (5) to obtain a digital conversion expression of formula (6) for converting the input signal z[n] into the impulse response signal p[n] by using the cascaded inverse system, as shown below:
$$\sum p [ n ] = ( \frac{1}{M} ) ( \sum z [ n ] + mz [ n ] + {M ( \sum z [ n ] + mz [ n ] )}^{′} ) ; \qquad ( 6 )$$
performing a differential calculation on two sides of the formula (6) to obtain formulas (7), (8), and (9), as shown below:
$$p [ n ] = ( \frac{1}{M} ) ( z [ n ] + {m ( z [ n ] )}^{′} + {M ( \sum z [ n ] + mz [ n ] )}^{″} ) \qquad ( 7 )$$
$$p [ n ] = ( \frac{1}{M} ) ( z [ n ] + {m ( z [ n ] )}^{′} + M ( {z [ n ]}^{′} + {mz [ n ]}^{″} ) ) \qquad ( 8 )$$
$$p [ n ] = \frac{\begin{matrix}( 1 + m + M + m \cdot M ) \cdot z [ n ] - ( m + M + 2 \cdot M \cdot m ) \cdot \\ 2 [ n - 1 ] + M \cdot m \cdot z [ n - 2 ]\end{matrix}}{M} ; \qquad ( 9 )$$
and
S3.4: sorting out the formula (8) to obtain a formula (10), as shown below:
$$p [ n ] = ( \frac{1}{M} ) ( z [ n ] + ( m + M ) {( z [ n ] )}^{′} + {Mmz [ n ]}^{″} ) = ( \frac{1}{M} ) ( δ [ n ] + ( m + M ) {( δ [ n ] )}^{′} + Mm {δ [ n ]}^{″} ) * z [ n ] ; \qquad ( 10 )$$
and
obtaining a system function expression of impulse shaping of the double-exponential signal according to the formula (10), as shown in a formula (11):
$$h 1 [ n ] = ( \frac{1}{M} ) ( δ [ n ] + ( m + M ) {( δ [ n ] )}^{′} + Mm {δ [ n ]}^{″} ) ; \qquad ( 11 )$$
and
S4: convolving the impulse signal with the target signal by using the cascaded convolution system to generate a cascaded impulse convolution shaping signal, and obtaining a function expression of the multistage cascaded shaping system.

2. The cascaded impulse convolution shaping method for the nuclear signal according to claim 1, wherein in S2,
the target signal comprises a standard Gaussian signal, a cosine-squared signal, a Cauchy distribution signal, and a trapezoidal signal; and the input signal is convolved with the target signal, and then impulse shaping is performed by using the cascaded inverse system, to generate the cascaded impulse convolution signal of the detector signal, wherein a function expression of the cascaded impulse convolution signal is obtained, as shown in a formula (23):
A2[n]=z[n]*g[n]*h[n] (23)
wherein A2[n] represents a function expression of the cascaded impulse convolution signal, z[n] represents a function expression of the input signal, g[n] represents an expression of the target signal, h[n] represents a system function expression of impulse shaping, and n represents the point sequence of the collected input signal.

3. The cascaded impulse convolution shaping method for the nuclear signal according to claim 1, wherein when the input signal z[n] is a single-exponential signal, m=0, and a system function expression of impulse shaping of the single-exponential signal is obtained according to formula (11), as shown in a formula (12):
$$h 2 [ n ] = ( \frac{1}{M} ) ( δ [ n ] + M \cdot {( δ [ n ] )}^{′} ) . \qquad ( 12 )$$

4. The cascaded impulse convolution shaping method for the nuclear signal according to claim 3, wherein S3 specifically comprises:
S3.1: when the input signal z[n] is a double-exponential signal with recoiling, inputting the input signal z[n] into the first-stage INV_RC system, wherein an output signal of the first-stage INV_RC system is y[n], the input signal z[n] is expressed by using a formula (13), and the output signal y[n] is expressed by using a formula (14):
$$z [ n ] = A ( \frac{m}{m - M} {e}^{- \frac{n}{M}} - \frac{M}{m - M} {e}^{- \frac{n}{m}} ) , m > M , n \geq 0 \qquad ( 13 )$$
$$y [ n ] = \sum z [ n ] + m . z [ n ] = z [ n ] * ε [ n ] * ( {m ( δ [ n ] )}^{′} + δ [ n ] ) ; \qquad ( 14 )$$
and
S3.2: deducing a system function expression of impulse shaping of the double-exponential signal with recoiling based on a procedure obtained according to the formula (11), as shown in a formula (15), wherein it is known that the formula (14) is a function expression of the first-stage INV_RC system:
$$h 3 [ n ] = \frac{1}{M} ( δ [ n ] + M . {( δ [ n ] )}^{′} ) * ε [ n ] * ( {m ( δ [ n ] )}^{′} + δ [ n ] ) = \frac{1}{M} ( δ [ n ] + ( m + M ) {( δ [ n ] )}^{′} + {Mm ( δ [ n ] )}^{″} ) * ε [ n ] . \qquad ( 15 )$$

5. The cascaded impulse convolution shaping method for the nuclear signal according to claim 4, wherein in S4,
the target signal comprises a standard Gaussian signal, a cosine-squared signal, a Cauchy distribution signal, and a trapezoidal signal; and the impulse signal is convolved with the target signal by using the cascaded convolution system to generate the cascaded impulse convolution shaping signal, wherein a function expression of the cascaded impulse convolution shaping signal is as shown in a formula (16):
A1[n]=z[n]*h[n]*g[n] (16):
wherein A1[n] represents the function expression of the cascaded impulse convolution shaping signal, h[n] represents a system function expression of impulse shaping, and g[n] represents an expression of the target signal.

6. The cascaded impulse convolution shaping method for the nuclear signal according to claim 5, wherein
when the target signal is the standard Gaussian signal, the impulse signal is convolved with the standard Gaussian signal to generate the cascaded impulse convolution shaping signal of the input signal, the formulas (11), (12), and (15) are substituted into the formula (16) separately, and then, based on the characteristic that the cascaded convolution of the multistage cascaded shaping system supports exchange of the convolution sequence, function expressions of the multistage cascaded shaping system are obtained, as shown in formulas (17), (18), and (19):
$$G 1 [ n ] = g [ n ] * h 1 [ n ] = \frac{1}{M} {Be}^{- \frac{{( n - b )}^{2}}{2 {c}^{2}}} * ( δ [ n ] + ( m + M ) {( δ [ n ] )}^{′} + M \cdot {m ( δ [ n ] )}^{″} ) \qquad ( 17 )$$
$$G 2 [ n ] = g [ n ] * h 2 [ n ] = \frac{1}{M} {Be}^{- \frac{{( n - b )}^{2}}{2 {c}^{2}}} * ( δ [ n ] + M \cdot {( δ [ n ] )}^{′} ) \qquad ( 18 )$$
$$G 3 [ n ] = g [ n ] * h 3 [ n ] = \frac{1}{M} {Be}^{- \frac{{( n - b )}^{2}}{2 {c}^{2}}} * ( δ [ n ] + ( m + M ) {( δ [ n ] )}^{′} + M \cdot {m ( δ [ n ] )}^{″} ) * ε [ n ] \qquad ( 19 )$$
wherein g[n] represents the function expression of the target signal, and the target signal herein is the standard Gaussian signal.

7. The cascaded impulse convolution shaping method for the nuclear signal according to claim 6, wherein the standard Gaussian signal is replaced by the cosine-squared signal or the Cauchy distribution signal, and the cosine-squared signal or the Cauchy distribution signal is convolved with the impulse signal to generate an impulse cosine-squared shaping signal of the detector signal or an impulse Cauchy distribution shaping signal of the detector signal, wherein a coefficient of digital Gaussian convolution is determined by a formula (20), a coefficient of cosine-squared convolution is determined by a formula (21), and a coefficient of digital Cauchy convolution is determined by a formula (22):
$$C 1 [ n ] = exp ( - ln ( 2 ) * {( \frac{n}{H} )}^{2} ) \qquad ( 20 )$$
$$C 2 [ n ] = {COS}^{2} ( π n / 2 H ) \qquad ( 21 )$$
$$C 3 [ n ] = {H}^{2} / ( {H}^{2} + 4 {n}^{2} ) , \qquad ( 22 )$$
wherein n represents the point sequence of the collected input signal, and H represents a half-width of the corresponding signal of each of the formulas.

8. A cascaded impulse convolution shaping apparatus for a nuclear signal, comprising:
a data collection unit configured to collect a detector signal in real-time and transmit the detector signal to an Advanced RISC Machines (ARM) processor by using a chip;
an impulse shaping unit configured to perform impulse shaping on the detector signal by using a cascaded inverse system to form an impulse signal, which
specifically comprises the following steps:
step 1: when an input signal z[n] is a double-exponential signal, inputting the input signal z[n] into a first-stage INV_RC system to output a single-exponential attenuation signal y[n], wherein the input signal z[n] is expressed by using a formula (1), and the single-exponential attenuation signal y[n] is expressed by using a formula (2):
$$z [ n ] = A ( {e}^{- \frac{n}{M}} - {e}^{- \frac{n}{m}} ) , m > M , n \geq 0 \qquad ( 1 )$$
$$y [ n ] = INV\_RC ( z [ n ] , m ) \qquad ( 2 )$$
wherein m and M represent system parameters of the double-exponential signal; n represents a point sequence of the collected input signal; and INV_RC represents inverse RC, wherein INV represents an inverse operation, and RC represents a resistor R and a capacitor C in a circuit, namely impacts from the RC in the circuit are removed through the inverse operation;
step 2: inputting the single-exponential attenuation signal y[n] into a second-stage INV_RC system to output an impulse response signal p[n], wherein the impulse response signal p[n] is expressed by using a formula (3):
$$p [ n ] = \frac{1}{M} INV\_RC ( y [ n ] , M ) \qquad ( 3 )$$
step 3: obtaining the following formulas (4) and (5) based on digital solution comprehensions of formulas (2) and (3) of an INV_RC operator:
$$\sum y [ n ] = \sum z [ n ] + mz [ n ] \qquad ( 4 )$$
$$\sum p [ n ] = ( \frac{1}{M} ) ( \sum y [ n ] + My [ n ] ) \qquad ( 5 )$$
substituting the formula (4) into the formula (5) to obtain a digital conversion expression of formula (6) for converting the input signal z[n] into the impulse response signal p[n] by using the cascaded inverse system, as shown below:
$$\sum p [ n ] = ( \frac{1}{M} ) ( \sum z [ n ] + mz [ n ] + {M ( \sum z [ n ] + mz [ n ] )}^{′} ) ; \qquad ( 6 )$$
and
performing a differential calculation on two sides of the formula (6) to obtain formulas (7), (8), and (9), as shown below:
$$p [ n ] = ( \frac{1}{M} ) ( z [ n ] + {m ( z [ n ] )}^{′} + {M ( \sum z [ n ] + mz [ n ] )}^{″} ) \qquad ( 7 )$$
$$p [ n ] = ( \frac{1}{M} ) ( z [ n ] + {m ( z [ n ] )}^{′} + M ( {z [ n ]}^{′} + {mz [ n ]}^{″} ) ) \qquad ( 8 )$$
$$p [ n ] = \frac{\begin{matrix}( 1 + m + M + m \cdot M ) \cdot z [ n ] - ( m + M + 2 \cdot M \cdot m ) \cdot \\ z [ n - 1 ] + M \cdot m \cdot z [ n - 2 ]\end{matrix}}{M} ; \qquad ( 9 )$$
and
step 4: sorting out the formula (8) to obtain a formula (10), as shown below:
$$p [ n ] = ( \frac{1}{M} ) ( z [ n ] + ( m + M ) {( z [ n ] )}^{′} + {Mmz [ n ]}^{″} ) = ( \frac{1}{M} ) ( δ [ n ] + ( m + M ) {( δ [ n ] )}^{′} + Mm {δ [ n ]}^{″} ) * z [ n ] ; \qquad ( 10 )$$
and
obtaining a system function expression of impulse shaping of the double-exponential signal according to the formula (10), as shown in a formula (11):
$$h 1 [ n ] = ( \frac{1}{M} ) ( δ [ n ] + ( m + M ) {( δ [ n ] )}^{′} + Mm {δ [ n ]}^{″} ) ; \qquad ( 11 )$$
a convolution shaping unit configured to convolve a target signal with the impulse signal formed by the impulse shaping unit to generate a cascaded impulse convolution shaping signal, wherein
when the target signal is a standard Gaussian signal, based on a characteristic that a cascaded convolution of a multistage cascaded shaping system supports exchange of a convolution sequence, a function expression of the multistage cascaded shaping system is obtained, as shown in a formula (17):
$$G 1 [ n ] = g [ n ] * h 1 [ n ] = \frac{1}{M} {Be}^{- \frac{{( n - b )}^{2}}{2 {c}^{2}}} * ( δ [ n ] + ( m + M ) {( δ [ n ] )}^{′} + M \cdot {( δ [ n ] )}^{″} ) \qquad ( 17 )$$
wherein g[n] represents a function expression of the target signal, and the target signal herein is the standard Gaussian signal; and
a Transmission Control Protocol (TCP)/Internet Protocol (IP) network configured to perform setting of parameters based on different detectors and signal adjustment circuits.

9. The cascaded impulse convolution shaping apparatus for the nuclear signal according to claim 8, wherein the target signal comprises the standard Gaussian signal, a cosine-squared signal, a Cauchy distribution signal, and a trapezoidal signal.
